(19) United States
(12) Patent Application Publication
(10) Pub. No.: US 2008/0316963 A1
(43) Pub. Date: Dec. 25, 2008

(54) CROSS LAYER OPTIMIZED MEDIUM ACCESS CONTROL

(75) Inventors: Weilan Huang, Beijing (CN); Khaled Ben Letaief, Hong Kong (CN)

Correspondence Address: AMIN, TUROCY & CALVIN, LLP, 127 Public Square, 57th Floor, Key Tower, CLEVELAND, OH, 44114, US

(73) Assignee: The Hong Kong University of Science and Technology, Hong Kong (CN)

(21) Appl. No.: 12/134,364

(22) Filed: Jun. 6, 2008

Related U.S. Application Data
(60) Provisional application No. 60/945,363, filed on Jun. 21, 2007.

(51) Int. Cl. H04Q 7/00

(52) U.S. Cl. 370/329

(57) ABSTRACT

Various embodiments of the disclosed subject matter provide cross layer medium access control systems and methods that dynamically adjusts each node's transmission probability according to physical layer characteristics. Accordingly, when a backoff time counter reduces to zero, each node can selectively transmit according to network population, current CSI, and MPR capability of the system. The disclosed details enable various refinements and modifications according to system design considerations.

### CROSS-REFERENCE TO RELATED APPLICATIONS

This application claims the benefit of priority under 35 U.S.C Section 119 from U.S. Provisional Patent Application Ser. No. 60/945,363 entitled “CROSS LAYER OPTIMIZED MEDIUM ACCESS CONTROL”, filed on Jun. 21, 2007.

### TECHNICAL FIELD

The subject disclosure relates to wireless networking and, more specifically, to cross layer optimizations for Medium Access Control (MAC) technologies.

### BACKGROUND

Wireless local area networks (WLANs) are becoming increasingly popular because of the high level of flexibility gained from wireless networking and the considerable cost savings available by mitigating cabling costs. Conventional designs for such systems follow a layered approach where there is no cross-optimization across the physical (PHY) layer and the medium access control (MAC) layer. However, the rapid increase in the demand for high data rates in WLAN systems requires a rethinking of the design principles, so that the system performance can be further enhanced by exploiting the interaction between the PHY and MAC layers.

Most WLANs are specified in the Institute of Electrical and Electronics Engineers (IEEE) 802.11 standard. The 802.11 protocols adopt a distributed coordination function (DCF) as a fundamental mechanism to access the medium. DCF is a random access scheme based on carrier sense multiple access with collision avoidance (CSMA/CA) protocol. The performance of such protocols has been investigated in depth. In some of these systems, it has also been shown that by tuning the 802.11backoff parameters, the protocol capacity can be significantly increased.

However, these systems were all designed purely from a MAC layer's point of view, regardless of the PHY layer characteristics. In particular, all of these designs adopted a simplistic collision model, which only supports one simultaneous transmission. Nevertheless, with advanced techniques of signal processing, multi-packet reception (MPR) has become a feasible solution in practical systems. While this brings new challenges, it also creates opportunities for the MAC design as well. Recently, random access protocols that are based on MPR models have been considered. However, all these previous works are restricted to the ALOHAnet system (or ALOHA, which is a computer networking system developed at the University of Hawaii and first deployed in 1970) and cannot be directly applied to 802.11 systems.

Another shortcoming of most existing 802.11 MAC designs is that such designs did not incorporate the channel state information (CSI) or channel condition into the active users' transmission process. In practice, the CSI or channel condition (e.g., characteristics of PHY channels in a wireless environment, such as fading and noise) has an important influence on the system performance. In order to deal with this problem, recent work has been done to improve the throughput by adjusting the transmission probability based on the exploitation of CSI. However, such work either assumes no MPR capability, or are limited to ALOHA systems.

As a result, conventional 802.11 MAC protocols that have been designed separately from the characteristics of the physical layer do not optimize the overall performance from a system point of view. Cross-layer optimized MAC systems and methods are desired for improving the overall system performance. The current WLAN MAC designs with above-described deficiencies are merely intended to provide an overview of some of the problems encountered in implementing a WLAN MAC, and are not intended to be exhaustive. Other problems with the state of the art may become further apparent upon review of the description of the various non-limiting embodiments of the disclosed subject matter that follows.

### SUMMARY

In partial consideration of the above-described deficiencies of the state of the art, various non-limiting embodiments of the disclosed subject matter provide channel state based random access protocol systems and methods that can facilitate taking advantage of multi-packet reception in wireless local area networks. In exemplary non-limiting embodiments, MAC systems and methods of the disclosed subject matter can facilitate dynamically adjusting each network node's transmission probability according to the network population, current channel condition, as well as the maximum number of packets that can be decoded simultaneously. System throughput can be analyzed and optimized by taking adaptive modulation and transmission errors into consideration, and an optimal transmission policy can then be obtained.

In various non-limiting embodiments, the disclosed subject matter provides systems and methods for accessing wireless networks that determine a current channel condition or state information for a network node and a channel state threshold. The current channel condition for the network node can be compared with the channel state threshold. Based in part on the comparison, at least “request to send” signal(s) can selectively be sent by the network node.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the disclosed subject matter in a simplified form as a prelude to the more detailed description that follows.

### BRIEF DESCRIPTION OF THE DRAWINGS

Embodiments of MAC systems and methods are further described with reference to the accompanying drawings in which:

FIG. 1 illustrates an exemplary non-limiting block diagram generally illustrating a network environment suitable for incorporation of various embodiments of the disclosed subject matter;

FIG. 2a illustrates a flowchart of an exemplary non-limiting process of accessing a wireless network according to various non-limiting embodiments of the disclosed subject matter;

FIG. 2b illustrates a process of accessing a wireless network according to further exemplary non-limiting embodiments of the disclosed subject matter;

FIG. 3 illustrates interaction and operation of system components in exemplary non-limiting embodiments of the disclosed subject matter;

FIG. 4 illustrates exemplary non-limiting formats of control frames suitable for use in various embodiments of the disclosed subject matter;

FIG. 5 illustrates an exemplary non-limiting wireless device suitable for performing various aspects of the disclosed subject matter;

FIG. 6 tabulates parameters that can be used to illustrate benefits available via incorporation of various non-limiting embodiments of the disclosed subject matter;

FIG. 7 illustrates throughput benefits available via incorporation of various non-limiting embodiments of the disclosed subject matter;

FIG. 8 illustrates the comparative throughput benefits via incorporation of various non-limiting embodiments of the disclosed subject matter in varying Signal to Noise Ratio (SNR) conditions;

FIG. 9 illustrates optimal values of p₀ and γ⁰ versus different network sizes;

FIG. 10 illustrates a block diagram representing an exemplary non-limiting networked environment in which embodiments of the disclosed subject matter can be implemented;

FIG. 11 illustrates a block diagram representing an exemplary non-limiting computing system or operating environment in which embodiments of the disclosed subject matter can be implemented; and

FIG. 12 illustrates an overview of a network environment suitable for service by embodiments of the disclosed subject matter.

### DETAILED DESCRIPTION

### Overview

Simplified overviews are provided in the present section to help enable a basic or general understanding of various aspects of exemplary, non-limiting embodiments that follow in the more detailed description and the accompanying drawings. This overview section is not intended, however, to be considered extensive or exhaustive. Instead, the sole purpose of the following embodiment overviews is to present some concepts related to some exemplary non-limiting embodiments of the disclosed subject matter in a simplified form as a prelude to the more detailed description of these and various other embodiments of the disclosed subject matter that follow. It is understood that various modifications can be made by one skilled in the relevant art without departing from the intended scope of the disclosed subject matter and the claims appended hereto. Accordingly, it is the intent to include within the scope of the exemplary non-limiting embodiments of disclosed subject matter those modifications, substitutions, and variations as may come to those skilled in the art based on the teachings herein.

As described above, conventional 802.11 MAC protocols that have been designed separately from the characteristics of the physical layer do not optimize the overall performance from a system point of view. In conventional 802.11 protocols, a node immediately transmits if the backoff time counter reduces to zero, regardless of the channel condition. In contrast to such schemes, in the cross-layer approach of the exemplary non-limiting embodiments of the disclosed subject matter, probability of the transmission can be controlled based on the estimated CSI or channel condition.

In consideration of these limitations, in accordance with the disclosed subject matter, exemplary non-limiting embodiments of MAC systems and methods can facilitate dynamically adjusting each node's transmission probability according to the current channel condition, as well as according to network population and a maximum number of packets that can be decoded simultaneously. In an aspect of the disclosed subject matter, an optimal transmission policy can depend on a determination and knowledge of MPR capability of a system and a number of active nodes in the system. In a further aspect of the disclosed subject matter, each node can determine whether to transmit or not in a distributed way, as long as it has such knowledge.

According to a further aspect of the disclosed subject matter, because the MPR capability of a system can remain relatively fixed over a relevant time period, it can become known to active nodes. In addition, a number of active nodes can be estimated based on an observation of channel status along with the number of idle slot, collisions, and successful transmissions. Moreover, according to various embodiments, each node can acquire its uplink channel state, for example, by estimating the channel gain during the downlink transmission from an access point (AP) to the nodes. As a result, each node's transmission can be dynamically controlled in a distributed way to achieve maximum throughput.

In various non-limiting embodiments of the disclosed subject matter, a CSI-based random access approach is provided for a WLAN network with MPR capability. Specifically, various non-limiting embodiments of a 802.11 DCF mode that adopts CSMA/CA with request-to-send/clear-to-send (RTS/CTS) mechanism is provided. In accordance with exemplary non-limiting embodiments of the disclosed subject matter, when the backoff time counter reduces to zero, each node can selectively transmit according to a transmit policy, which, according to various embodiments can comprise a function of network population, current CSI, and MPR capability of a system. Unlike conventional approaches where a centralized controller is assumed to decide the retransmission probability, nodes implemented according to various non-limiting embodiments of the disclosed subject matter can decide in a distributed fashion by using, for example a signal-to-noise (SNR) threshold.

Moreover, in various embodiments of the disclosed subject matter, modulation types can be dynamically and adaptively selected to efficiently utilize system resources. Based on exemplary non-limiting MAC systems and methods of the disclosed subject matter, a throughput expression can be derived, and the optimal channel threshold can be obtained to maximize this throughput. As a result of using MPR, collisions can be effectively reduced while increasing the number of simultaneous transmissions. Additionally, controlling transmission probability with the use of CSI or channel condition can advantageously avoid considerable transmission errors, thereby facilitating efficient utilization of system resources by exploiting multi-user diversity. As a result, throughput can be significantly increased, without sacrificing system resources such as bandwidth and transmission energy, compared to the schemes using conventional models.

According to further non-limiting embodiments of the disclosed subject matter, MPR at the PHY layer can be implemented using various multiple access schemes, such as time division multiple access (TDMA), frequency division multiple access (FDMA), code division multiple access (CDMA), as well as orthogonal frequency division multiple access. As described below for various non-limiting embodiments of the disclosed subject matter, orthogonal CDMA can be used to demonstrate the efficiency of MPR.

According to further non-limiting embodiments of the disclosed subject matter, adaptive modulation techniques can be utilized to increase the spectral efficiency by adapting the transmission rate while maintaining an acceptable bit error rate (BER). According to still further non-limiting embodiments of the disclosed subject matter, a throughput expression can be derived by taking the transmission errors into consideration (e.g., as a function of the SNR threshold). Based on the throughput expression, the optimal transmission policy corresponding to the optimal SNR threshold can be obtained to enable the system to achieve the maximum throughput. As will be appreciated, this can be shown to result in significant improvement in system throughput, compared to the schemes where no MPR is adopted, or where nodes immediately transmit when the backoff time counters become zero, regardless of the channel conditions.

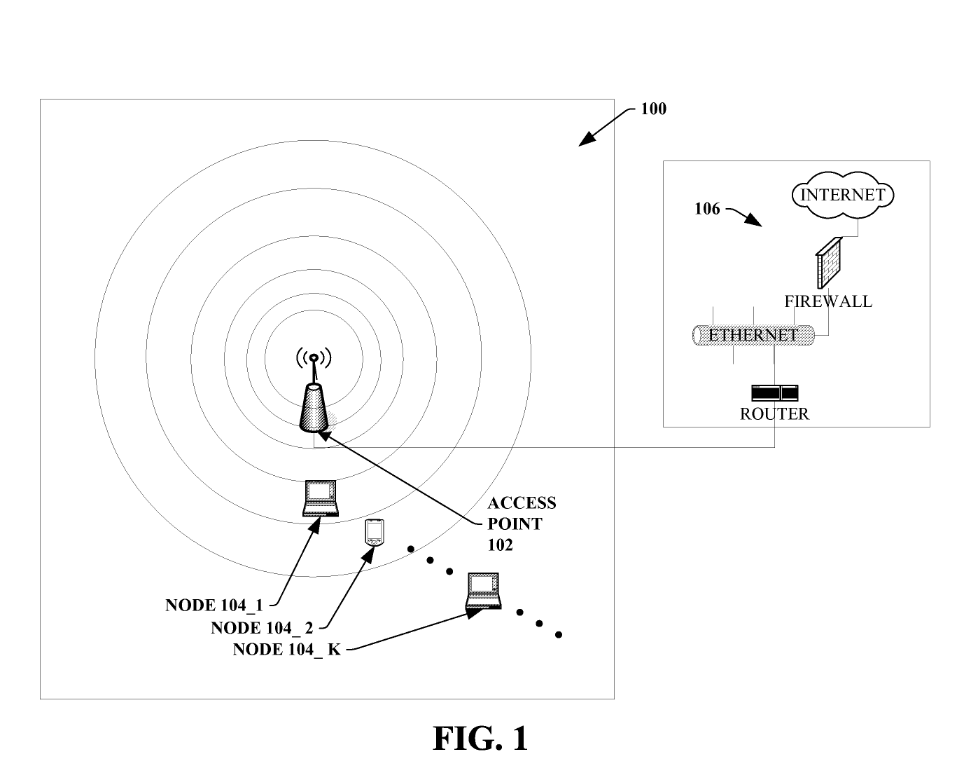

FIG. 1 is an exemplary non-limiting block diagram generally illustrating a network environment 100 suitable for incorporation of various embodiments of the disclosed subject matter. Network environment 100 contains a number of nodes 104 operable to communicate with a wireless Access Point (AP) or access component 102 over a wireless communication medium and according to an agreed protocol (e.g. IEEE 802.11b). FIG. 1. illustrates that there can be a number of nodes, and it can be appreciated that due to differences in transmission path, node characteristics, and other variables, channel state at each node is likely to be different than a neighboring node. Alternatively, access point 102 can be connected to other suitable network systems.

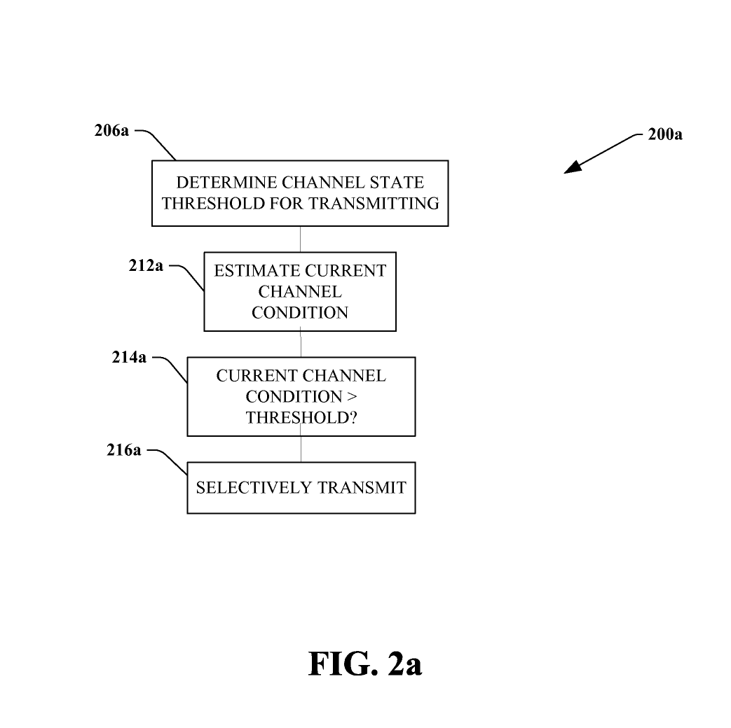

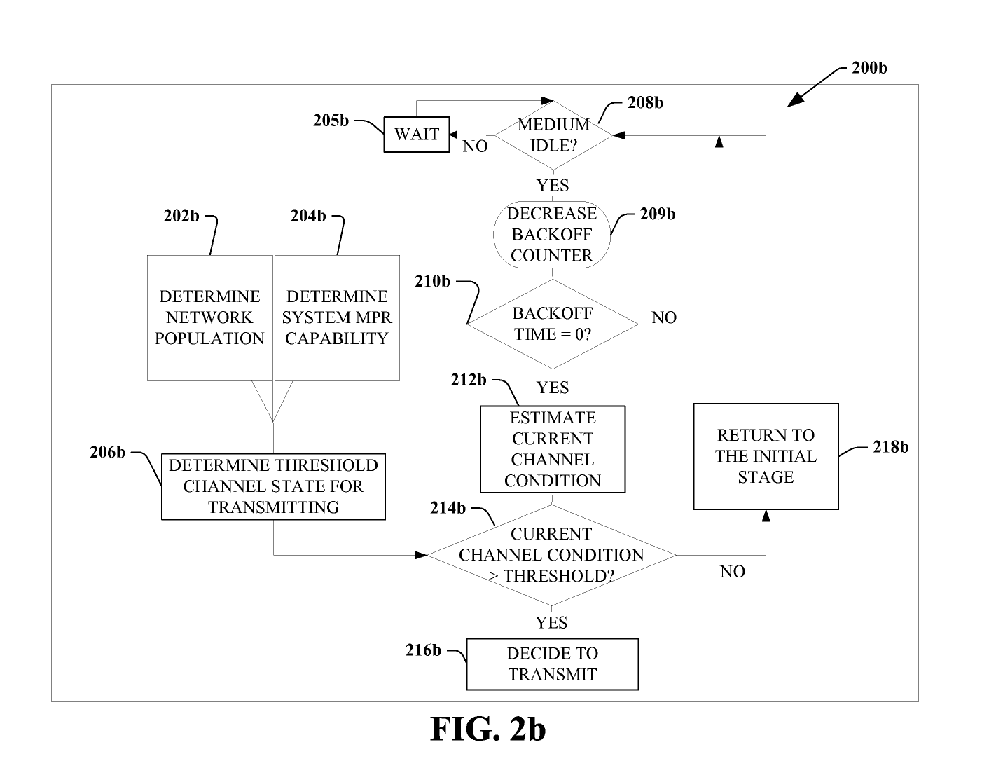

FIG. 2a illustrates a flowchart 200a of an exemplary non-limiting process of accessing a wireless network according to various non-limiting embodiments of the disclosed subject matter. Accordingly, at 206a a channel state threshold for transmitting can be determined. At 212a, current channel condition can be estimated. At, 214a, the channel state threshold can be compared with the estimated current channel condition (e.g., CSI) to determine whether the current channel condition satisfies the channel state threshold for transmitting. At 216a, nodes 104 of the system can selectively transmit 216a to the access point 102, based in part on the outcome of the determination at 214a.

FIG. 2b illustrates a process 200b of accessing a wireless network according to further exemplary non-limiting embodiments of the disclosed subject matter. According to various embodiments of the disclosed subject matter, wireless network multi-packet reception (MPR) capabilities at the PHY layer (not shown) can be implemented through using various multiple access schemes, such as TDMA, FDMA, code division multiple access, as well as orthogonal frequency division multiple access.

Accordingly, in various embodiments of the disclosed subject matter, at 202b, a network population (e.g., number of active nodes) can be determined. In addition, at 204b, the wireless network MPR capabilities can be determined. As a result, a threshold channel state can determined at 206b based at least in part on the wireless network MPR capabilities 204b and network population 202b (e.g., number of active nodes).

According to further aspects of the disclosed subject matter, a determination of whether a medium is idle can be made at 208b. At 205b, the medium can wait based on the determination that the medium is not idle at 208b. At 209b, a backoff counter can be decreased based on the determination that the medium is idle at 208b. At 210b, a determination can be made whether backoff time is equal to zero. If the outcome of the determination at 210b is that the backoff time is not equal to zero, then according to various embodiments of the disclosed subject matter, the determination of whether a medium is idle can continue or repeat at 208b.

According to various embodiments of the disclosed subject matter, if the outcome of the determination at 210b is that the backoff time is equal to zero, then the determination of whether transmit (e.g. selective transmission) on the basis of estimated channel conditions and channel state threshold for transmitting can proceed. Accordingly, at 212b, current channel condition can be estimated. At, 214b, the channel state threshold can be compared with the estimated current channel condition (e.g., CSI) to determine whether the current channel condition satisfies the channel state threshold for transmitting. At 216b, nodes 104 of the system can selectively transmit 216b to the access point 102, based in part on the determination at 214b that the current channel condition satisfies the channel state threshold for transmitting. Alternatively, at 218b, nodes 104 of the system can return to the initial stage (MEDIUM IDLE?) 208b to the access point 102, based in part on the determination at 214b that the current channel condition does not satisfy the channel state threshold for transmitting.

It is to be appreciated that, while for ease of illustration the various blocks of FIGS. 2a and 2b depict a particular order or sequence of determinations or other actions, the various embodiments of the disclosed subject matter are not so limited. For example, although determinations or other actions are shown to be performed in a particular sequence it should be understood that the disclosed sequence may be altered such that some determinations or other actions, or portions thereof can be performed concurrently, or otherwise.

In the below description, various exemplary system model(s) and frame structures according to embodiments of the disclosed subject matter are presented as a foundation for presenting further embodiments of the disclosed systems and methods. Next, exemplary non-limiting embodiments of systems and methods of the disclosed subject matter are presented. Then, benefits available via incorporation of various non-limiting embodiments of the disclosed subject matter are presented.

### System Models

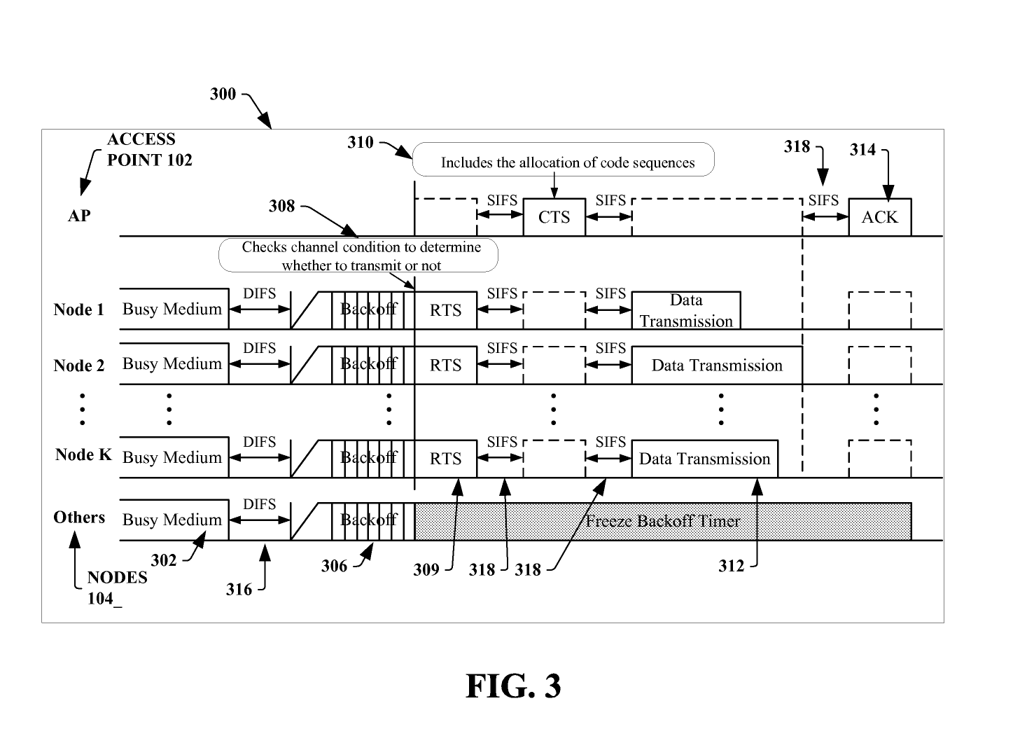

FIG. 3 illustrates interaction and operation of system components in exemplary non-limiting embodiments of the disclosed subject matter FIGS. 1-3 can provide foundation for the various embodiments of the disclosed subject matter described in more detail below. Implementation environments and operation of exemplary non-limiting embodiments of the claimed MAC systems and methods are shown in FIGS. 1 and 2 and more specifically in FIG. 3.

Consider uplink transmission of a WLAN (100, 300) where a number of nodes 104_1 -104_K communicate with an access point 102. It is assumed for example that there can be n nodes 104 in the system 300, and the total system bandwidth is Bₜ. According to various embodiments of the disclosed subject matter, different nodes 104 can be allowed to transmit simultaneously by using MPR at a receiver (not shown) of the AP 102. Specifically, it can be assumed that a CDMA protocol can be adopted based on the use of orthogonal sequences (e.g., Walsh-Hadamard codes). Accordingly, the receiver at the AP 102 side can consist of a bank of matched filters (not shown). The maximum number of packets that AP 102 can decode simultaneously, N, which can be referred to as MPR capability, can be said to be equal to the number of available code sequences in the network. As a result, it can be assumed that the symbol rate of each transmission is B=Bₜ/N.

The channel state between each node 104 and the AP 102 can be parameterized by the value of SNR γ. Specifically,

γ=|h|²Pₜ/N₀B, (1)

where h denotes the instantaneous channel gain, No denotes the noise power spectral density, and Pₜ is the transmit power. It can be assumed that the channels for all the nodes 104 are independent and identically distributed (i.i.d.) random variables with a probability density function (PDF) ƒ(γ). The associated cumulative density function (CDF) can be denoted as F(γ).

Note that, according to various embodiments of the disclosed subject matter, each node 104 can acquire its uplink channel state (212) by estimating the channel gain during the downlink transmission from AP 102 to the nodes 104. In the conventional 802.11 protocols, the node 104 immediately transmits if the backoff time counter reduces to zero (e.g., at 209b of FIG. 2), regardless of the channel condition. In contrast to such schemes, various non-limiting embodiments of the disclosed subject matter can utilize a cross-layer approach where the probability of the transmission can be controlled based on the estimated channel condition or CSI (e.g., at 212 or 308) using a transmission control policy or control policy (e.g. at 216 or 308).

Advantageously, such a control policy can be used to facilitate reducing nodes' collision and improve transmission rate by exploiting multi-user diversity, according to various embodiments of the invention. Referring to FIGS. 2 and 3, before nodes 104 initiate a transmission, the nodes 104 can sense the medium to determine whether there is any pending transmission (e.g., at 208b or 302). If the medium is found to be idle (208), for example, for an interval that exceeds the distributed inter-frame space (DIFS) 316, each node can choose a backoff counter value. According to an aspect of the disclosed subject matter, nodes can choose a backoff counter value that can be uniformly distributed in the range of [0, Wᵢ−1], where Wᵢ stands for the contention window (i denotes the backoff stage. Wᵢ is maintained in units of slots and is initially set to be W₀).

According to various embodiments of the disclosed subject matter, after the backoff time (e.g., affirmative determination that backoff time equals zero), node 104 can check its γ (212 or 308). Based on the estimated channel condition and the transmission control policy, node 104 can decide whether to transmit or not (214-216 and 312). If the channel condition satisfies the transmission control policy (214 or 308) such that the node 104 chooses to transmit 216 (if the node decides not to transmit (218), it can return to the initial backoff stage (205)), a code sequence can then be randomly selected for the RTS packet 309 to send the request for access to AP 102. After a short inter-frame space (SIFS) 318, the AP 102 can then broadcast access grant signals (e.g., including information of specified code sequences) via a CTS packet to notify nodes 104 whose RTS packets are successfully detected (e.g., at 3 10).

Once the CTS packet is received by selected nodes 104, admitted nodes can wait for a SIFS interval 318, and can then transmit data packets 312 using the chosen modulation (e.g., a modulation which can be determined based in part on channel conditions). If the data packet 312 is correctly received, AP 102 can return an acknowledgement (ACK) 314 to nodes 104 after a SIFS interval 318. Note, according to an aspect of the disclosed subject matter, a retransmission can be required if there is no CTS or ACK detected within a predetermined period, (e.g., CTSₜᵢₘₑₒᵤₜ or ACKₜᵢₘₑₒᵤₜ). According to further aspects, in such case where retransmission is required, the backoff stage can be increased by an amount (e.g., one (1)), and the contention window can be correspondingly doubled until it reaches Wₘ, where m can denote the maximum backoff stage.

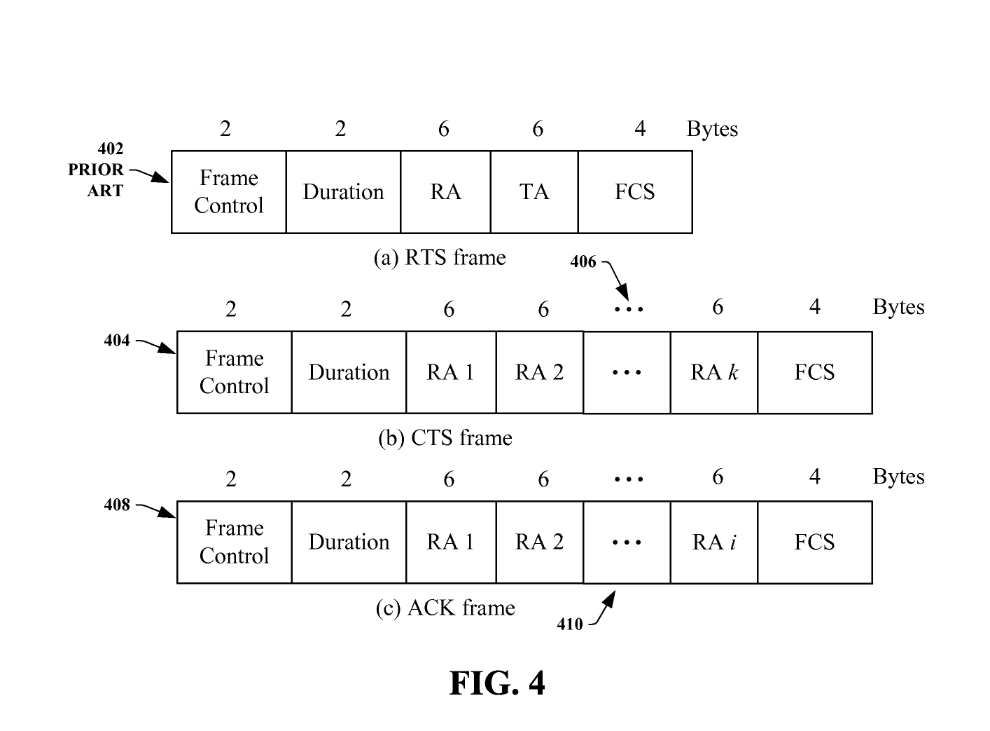

FIG. 4 illustrates exemplary non-limiting formats of control frames suitable for use in various embodiments of the disclosed subject matter. According to various embodiments of the disclosed subject matter, the structure of suitable RTS frame 402 can be the same as that defined for 802.11. According to further embodiments of the disclosed subject matter, suitable CTS frames 404 can comprise multiple receiver address (RA) fields 406 (e.g., RA1 to RAk in 404). According to still further embodiments of the disclosed subject matter, suitable ACK frame 408 can comprise multiple RA fields 410 (e.g., RA1 to RAi in 408). Advantageously, the multiple RA fields enable the CTS frames 404 and ACK frames 408 to accommodate multiple transmissions. According to an aspect of the disclosed subject matter, the number of RA fields 406 in the CTS frame 404 can be equal to the number of successfully received RTS packets 309, while the RA fields 410 in the ACK frame 408 can be used to acknowledge the nodes 104 with successful data transmissions.

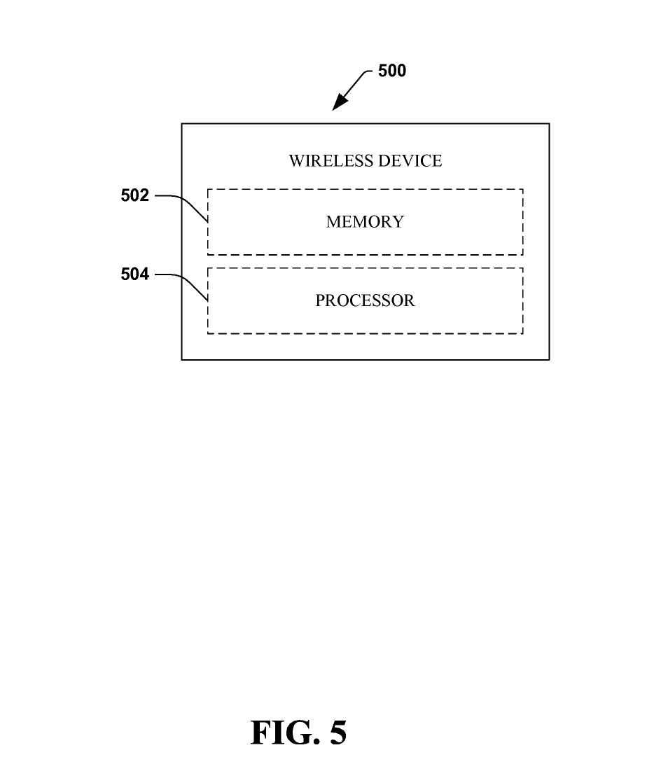

FIG. 5 illustrates an exemplary non-limiting wireless device 500 suitable for performing various aspects of the disclosed subject matter. The wireless device 500 can be a stand-alone device or a portion thereof or a specially programmed computing device or a portion thereof (e.g., a memory retaining instructions for performing the techniques as described herein coupled to a processor). Wireless device 500 can include a memory 502 that retains various instructions with respect to selectively transmitting based on channel state.

For instance, wireless device 500 can include a memory 502 that retains instructions for determining a current channel condition for a node of the wireless network. The memory 502 can further retain instructions for determining a current channel condition for the wireless device. Additionally, memory 502 can retains instructions for determining a channel state threshold, upon which, the wireless can transmit according to the disclosed subject matter. In addition, memory 502 can retains instructions for comparing the current channel condition for the node with the channel state threshold. Still further, memory 502 can retains instructions for selectively transmitting at least a request to send signal, based on the comparing of the current channel condition for the node with the channel state threshold. The above example instructions and other suitable instructions can be retained within memory 502, and a processor 504 can be utilized in connection with executing the instructions.

### Performance Analysis

Denoting P(A|γ) as the conditional probability that an event A occurs with respect to γ. In particular non-limiting embodiments of the claimed invention, A can denote the event that node 104 transmits when its backoff counter reduces to 0 (e.g., at 209b). p₀ can denote the average probability that the event A occurs as follows:

$${p}_{0} = {\int }_{γ} P ( A \vert γ ) f ( γ ) d γ . \qquad ( 2 )$$

According to particular embodiments of the disclosed subject matter, nodes 104 associated with a high γ transmit using a higher probability, while transmission probability is reduced when the value of γ is low. Although it is to be appreciated that suitable alternatives to a step function could be substituted for transmission control, for ease of demonstration and explanation of embodiments of the disclosed subject matter, it can be assumed that transmission control is a step function with respect to an SNR threshold. That is,

$$P ( A \vert γ ) = \{ \begin{matrix}1 & γ \geq {γ}_{0} \\ 0 & γ < {γ}_{0} .\end{matrix} \qquad ( 3 )$$

### From Eqn. (2) and Eqn. (3):

$${p}_{0} = {\int }_{{γ}_{0}}^{∞} f ( γ ) d γ = 1 - F ( {γ}_{0} ) , \qquad ( 4 )$$

where γ₀ can denote the threshold for controlling the transmission. According to an aspect of the disclosed subject matter, selection of γ₀ can depend on the number of nodes 104 and MPR capability of the system (e.g., system 100, 300). According to particular embodiments of the disclosed subject matter, γ₀ can be chosen (e.g., at 206) to maximize system throughput as further provided below. Moreover, from the above equation, it can be appreciated that p₀ is an injective function of γ₀.

The development and explanation of the throughput expression as a function of p₀ and the optimization of transmission probability p₀ (and hence SNR threshold γ₀) that maximizes system throughput are provided below.

### Throughput Expression

According to particular embodiments of the disclosed subject matter, a throughput expression can be provided by first examining the behavior of a single node 104 based on transmission control. For example, it can assumed that the average frame error rate of the data packets is F̅E̅R̅ and the probability that the RTS packet encounters a collision is p_{b}. Using an established Markov model, the stationary probability, τ, that a node 104 transmits a packet in a generic slot time can be derived as

$$τ = \frac{2 {p}_{0} ( 1 - 2 {p}_{c} )}{( 1 - 2 {p}_{c} ) ( {W}_{0} + 1 ) + {p}_{c} {W}_{0} ( 1 - {( 2 {p}_{c} )}^{m} )} , \qquad ( 5 )$$

where p_{c}=p₀(p_{b}+ F̅E̅R̅−p_{b}· F̅E̅R̅). Note that p_{c} can represents the total collision probability, due to the RTS 309 collision as well as the data packet errors.

It can be appreciated that because each node 104 randomly selects a code sequence for sending its RTS packet according to an aspect of the disclosed subject matter, collision can occur if different nodes 104 select the same sequence. As a result, p_{b} can be obtained as

$${p}_{b} = {\sum }_{k = 0}^{n - 1} ( 1 - {( \frac{N - 1}{N} )}^{k} ) ( \begin{matrix}n - 1 \\ k\end{matrix} ) {{τ}^{k} ( 1 - τ )}^{n - 1 - k} . \qquad ( 6 )$$

Moreover, F̅E̅R̅ can be calculated given the target bit error rate BERₜ,

F̅E̅R̅=1−(1−BERₜ)^{L}, (7)

where L=l+MAC_{hdr}, l can denote the packet payload size, and MAC_{hdr} can denote the MAC header length. By substituting Eqns. (6) and (7) into (5), r can be defined as a function of p₀.

Denoting Xⱼₖ as the conditional probability that, given j nodes 104 transmit RTS 309 packets, k out of j are successfully detected. In particular embodiments of the disclosed subject matter, Xⱼₖ can be derived as

$${X}_{jk} = ( \begin{matrix}N \\ k\end{matrix} ) [ {\sum }_{x = 0}^{min ( N - k , j - k )} {( - 1 )}^{x} ( \begin{matrix}N - k \\ x\end{matrix} ) \frac{j !}{( j - k - x ) !} {( \frac{1}{N} )}^{k + x} {( 1 - \frac{k + x}{N} )}^{j - k - x} ] . \qquad ( 8 )$$

Additionally, Pₜᵣ denotes the probability that there is at least one transmission in the slot time. Accordingly,

Pₜᵣ=1−(1−τ)ⁿ. (9)

Denoting Pₜₖ as the probability that k data packets simultaneously transmit, which is equivalent to the probability that k RTS packets are successfully received. Then,

$${P}_{tk} = {\sum }_{j = 1}^{n} {X}_{jk} {P}_{j} , \qquad ( 10 )$$

where Pⱼ denotes the probability that j nodes 104 simultaneously transmit RTS packets, e.g.,

$${P}_{j} = ( \begin{matrix}n \\ j\end{matrix} ) {{τ}^{j} ( 1 - τ )}^{n - j} . \qquad ( 11 )$$

Moreover, denoting Pₛₖⁱ as the conditional probability that given k data packets 312 transmitted, i of them are successfully received. According to an aspect of the disclosed subject matter, the channel conditions and transmissions of different nodes can be assumed to be independent, so that Pₛₖⁱ can be expressed as

$${P}_{sk}^{i} = ( \begin{matrix}k \\ i\end{matrix} ) {( 1 - \overline{F E R} )}^{i} {( \overline{F E R} )}^{k - i} , i = 0 , 1 , … , k . \qquad ( 12 )$$

The system throughput S can be defined as the ratio of payload information bits being transmitted to the total amount of time spent to successfully transmit the payload. Specifically, S is given by

$$\begin{matrix}S = \frac{E [ payload information bits transmitted in a slot time ]}{E [ length of a slot time ]} \\ = \frac{{\sum }_{k = 1}^{N} {kP}_{tk} ( 1 - \overline{F E R} ) E [ l ]}{\begin{matrix}( 1 - {P}_{tr} ) σ + {\sum }_{k = 1}^{N} {P}_{tk} {\sum }_{i = 1}^{k} {P}_{sk}^{i} E [ {T}_{sk}^{i} ] + \\ {\sum }_{k = 1}^{N} {P}_{ek} E [ {T}_{ek} ] + ( {P}_{tr} - {\sum }_{k = 1}^{N} {P}_{tk} ) {T}_{c}\end{matrix}} .\end{matrix} \qquad ( 13 )$$

In equation (13), E[l] denotes the average packet payload size. According to particular embodiments of the disclosed subject matter, it can be assumed that all packets have the same length, e.g. E[l]=1. σ can denote the duration of an idle slot time, and E[Tₛₖⁱ] can denote the average time spent when k data packets 312 transmit and i of them are correctly received. Likewise, E[Tₑₖ] can denote the average time spent when k data packets 312 transmit and all of them are received in error, and the associated probability is Pₑₖ=PₜₖPₛₖ⁰. T_{c} denotes the average time spent for collisions. In various embodiments of the disclosed subject matter, the values of E[Tₛₖⁱ], E[Tₑₖ] and T_{c} are specified as follows:

$$\begin{matrix}E [ {T}_{sk}^{i} ] = RTS + {CTS}_{k} + 3 S I F S + D I F S + {ACK}_{i} + 4 δ + P H {Y}_{h d r} + E [ {t}_{k} ] , & ( 14 ) \\ E [ {T}_{ek} ] = RTS + {CTS}_{k} + 2 S I F S + D I F S + 3 δ + P H {Y}_{h d r} + E [ {t}_{k} ] , & ( 15 ) \\ {T}_{c} = RTS + D I F S + δ . & ( 16 )\end{matrix}$$

Here δ can denote the propagation delay and PHY_{hdr} can denote the physical header length. CTSₖ denotes the length of CTS 404 packet which includes k RA fields 406 and similarly ACKᵢ includes i RA fields 410. E[tₖ] can denote the average time spent for the transmission of k simultaneous data packets 312 (including the payload and MAC header.)

Next, the value of E[tₖ] with respect to p₀ can be provided as follows. It can be understood that data transmission time can be dominated by the node 104 with the worst channel, which can result in reduction of transmission rate to a minimum. Assuming that adaptive Multi-Level Quadrature Amplitude Modulation (M-QAM) can be used, the number of bits that can be transmitted within each symbol can be approximated as

b=log₂(1+c·γ), (17)

where c=−1.5/ln(5BERₜ). On the other hand, Rayleigh fading can be assumed for wireless channels with PDF

ƒ(γ)=(1/ γ̅)e^{-(γ/ γ̅)}(γ≧0), (18)

where γ̅ is the average SNR. From Eqn. (4)

γ₀= γ̅ln p₀. (19)

As a result, E[tₖ] can be obtained as

$$\begin{matrix}E [ {t}_{k} ] = E [ \frac{L}{min ( b ( γ ) )} \vert {p}_{0} ] \\ = \frac{k}{{( {p}_{0} )}^{k}} \cdot {\int }_{{γ}_{0}}^{∞} \frac{L}{B {log}_{2} ( 1 + c \cdot γ )} {( 1 - F ( γ ) )}^{k - 1} f ( γ ) d γ \\ = \frac{k}{{( {p}_{0} )}^{k}} \cdot {\int }_{- \overline{γ} ln {p}_{0}}^{∞} \frac{L}{\overline{γ} B {log}_{2} ( 1 + c \cdot γ )} {( {e}^{- \frac{γ}{\overline{γ}}} )}^{k} d γ ,\end{matrix} \qquad ( 20 )$$

where F(·) denotes the CDF of γ.

By substituting Eqns. (14), (15), (16) and (20) into (13), S can be defined as a function of p₀.

### Implementation of Transmission Control

Recall that, according to various embodiments of the disclosed subject matter, the SNR threshold γ₀ can be used to control transmission, which according to an aspect can be exclusively determined by p₀. Based on the derived throughput expression, according to an aspect of the disclosed subject matter, the value of p₀ or the corresponding γ₀ can be adjusted such that the throughput can be maximized. Accordingly, the optimal value of p₀ can be denoted by p*₀. Advantageously, a one-dimensional search procedure such as the Bisection method, Newton-Raphson method, Secant method, and the like can then be applied to obtain the optimal solution, according to various embodiments of the disclosed subject matter.

As provided above, the selection of the optimal γ₀ can depend, at least in part, on the determination and knowledge of the MPR capability and number of active nodes 104 in the system (e.g., system 300). Accordingly, as described above, each node 104 can decide whether to transmit or not in a distributed way, as long as it has such knowledge. Because MPR capability of the system remains stationary during a relatively long time period, according to an aspect of the disclosed subject matter, MPR capability can be known a priori to a relative degree of certainty, or at least within an allowable degree of uncertainty. Moreover, the number of active nodes can be estimated, according to a further aspect, based on the observation of the channel status along with the number of idle slots, collisions, and successful transmissions. As a result, various embodiments of the disclosed subject matter can advantageously facilitate dynamic control of each node's transmission in a distributed way to achieve maximum throughput.

### Adaptive Modulation Using Discrete Constellations

For the purposes of illustration and not limitation, it has been assumed above that the rate of M-QAM scheme is continuous. However, in practical implementations, a set of discrete rate M-QAM can be adopted. For example, it can be assumed that the transmission rates available in the system are bᵢ,i=1, . . . ,M. In such a case, a set of corresponding thresholds can determine the SNR regions for the transmission rates, according to various embodiments of the disclosed subject matter. Such thresholds can be denoted by γᵢ,i=1, . . . , (M+1) with Γ_{M+1}=∞, where, for example, if Γᵢ≦γ<Γᵢ₊₁, the rate of bᵢ will be selected. Specifically, to guarantee the target Bit Error Rate (BER), Γᵢ can be selected as

$$\begin{matrix}{Γ}_{i} = - ln ( 5 B E {R}_{t} ) / {g}_{i} , i = 1 , … , M , where & ( 21 ) \\ {g}_{i} = \{ \begin{matrix}1.5 / ( {2}^{{b}_{i}} - 1 ) & {b}_{i} is even \\ 6 / ( 5 \cdot {2}^{{b}_{i}} - 4 ) & {b}_{i} is odd .\end{matrix} & ( 22 )\end{matrix}$$

Then, the F̅E̅R̅ and E[tₖ]⁻³ can be derived. If BERₜ is small enough, 1−(1−BERₜ(γ))^{L}≈L·BERₜ(γ). Letting aᵢ₊₁(p₀)=max(Γᵢ₊₁,− γ̅ln p₀) and aᵢ(p₀)=max(Γᵢ,− γ̅ln p₀),

$$\begin{matrix}\overline{F E R} ( {p}_{0} ) \approx \frac{L}{{p}_{0}} [ {\sum }_{i = 1}^{M} {\int }_{{a}_{i} ( {p}_{0} )}^{{a}_{i + 1} ( {p}_{0} )} B E {R}_{i} ( γ ) f ( γ ) d γ ] \\ = \frac{L}{5 {p}_{0}} {\sum }_{i = 1}^{M} \{ \frac{1}{\overline{γ} {g}_{i} + 1} [ {e}^{- ( {g}_{i} + \frac{1}{\overline{γ}} ) {a}_{i} ( {p}_{0} )} - {e}^{- ( {g}_{i} + \frac{1}{\overline{γ}} ) {a}_{i + 1} ( {p}_{0} )} ] \} .\end{matrix} \qquad ( 23 )$$

On the other hand, E[tₖ] can be derived as

$$\begin{matrix}E [ {t}_{k} ] = \frac{k}{{( {p}_{0} )}^{k}} \cdot [ {\sum }_{i = 1}^{M} {\int }_{{a}_{i} ( {p}_{0} )}^{{a}_{i + 1} ( {p}_{0} )} \frac{L}{B \cdot {b}_{i}} {( 1 - F ( γ ) )}^{k - 1} f ( γ ) d γ ] \\ = \frac{L}{{( {p}_{0} )}^{k} \cdot B} {\sum }_{i = 1}^{M} ( {e}^{- \frac{k}{\overline{γ}} {a}_{i} ( {p}_{0} )} - {e}^{- \frac{k}{\overline{γ}} {a}_{i + 1} ( {p}_{0} )} ) / {b}_{i} .\end{matrix} \qquad ( 24 )$$

Note that in the conventional scheme, each node transmits once its backoff time counter is reduced to zero, regardless of the channel condition. This implies that, in such scheme p₀=1 and accordingly Γ₁ is set to be zero. As a result,

$$\begin{matrix}\overline{F E R} = {\sum }_{i = 1}^{M} {\int }_{{Γ}_{i}}^{{Γ}_{i + 1}} [ 1 - {( 1 - B E {R}_{i} ( γ ) )}^{L} ] f ( γ ) d γ , and & ( 25 ) \\ E [ {t}_{k} ] = \frac{L}{B} {\sum }_{i = 1}^{M} ( {e}^{- \frac{k}{\overline{γ}} {Γ}_{i}} - {e}^{- \frac{k}{\overline{γ}} {Γ}_{i + 1}} ) / {b}_{i} . & ( 26 )\end{matrix}$$

### Performance Evaluation

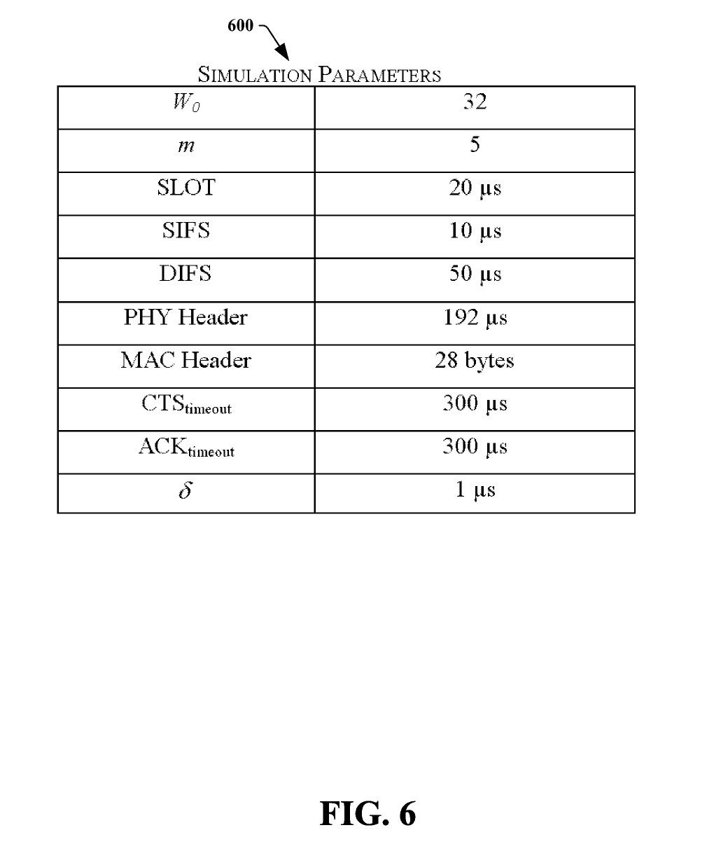

In this section, the performance of particular non-limiting embodiments is demonstrated to illustrate the efficacy of the various embodiments of the disclosed MAC systems and methods. Assume, for example, a system having a total bandwidth of 20 Mega-Hertz (MHz) and the number of available code sequences (Walsh-Hadamard sequences) N to be 4. The wireless channels can be modeled as i.i.d. flat Rayleigh fading channels for all the stations. In addition, the near-far effect can be assumed to be compensated by using power control. The target BER can be chosen to be BERₜ=10⁻⁶, and the packet payload size can be 1023 bytes. According to particular non-limiting embodiments, the RTS 402, CTS 404, and ACK 408 frames can be transmitted at a mandatory rate of 1 Mbps. The values of the other parameters for the particular non-limiting embodiments are summarized in the table of FIG. 6, which comprise typical specifications for IEEE 802.11b. Finally, it can be assumed that the modulation types available in the particular non-limiting embodiments are from Binary Phase-Shift Key modulation (BPSK) to 256 QAM.

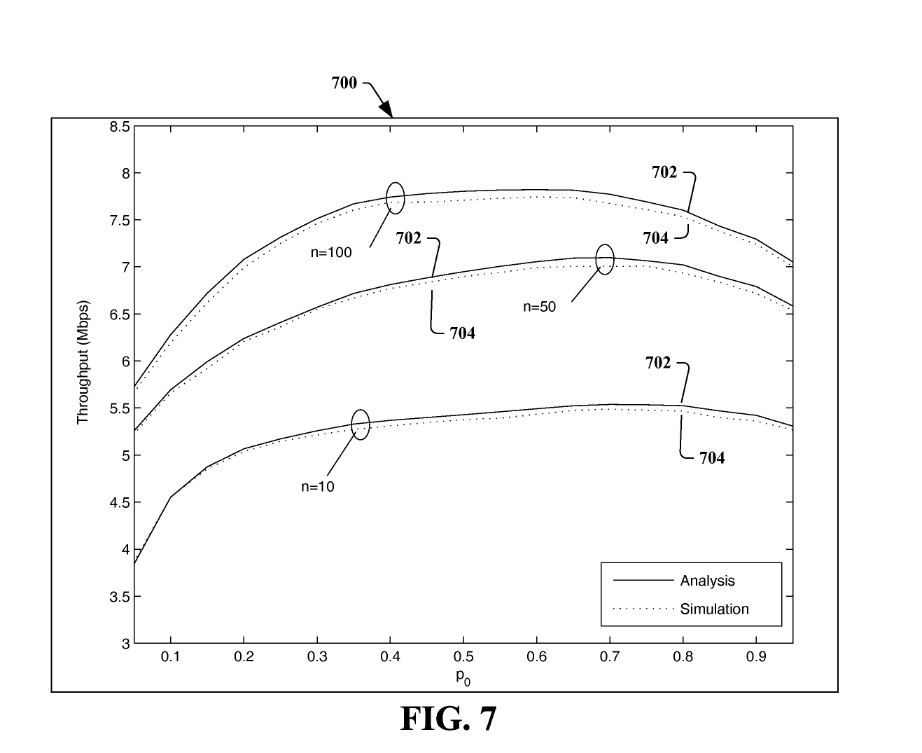

FIG. 7 illustrates throughput benefits available via incorporation of various non-limiting embodiments of the disclosed subject matter. For example, FIG. 6 shows the throughput achieved 702 by the particular non-limiting embodiments of the disclosed subject matter as well as simulations 704, under different numbers of nodes 104 in the network (e.g., n=10, 50, 100). An average SNR of 25 Decibel (dB) is assumed. As can be seen in FIG. 7, the simulation results are shown to be consistent with the analysis in all cases. In addition, it is recognized that the throughput increases as the number of nodes 104 becomes larger, due to the efficiency of the channel utilization being improved in the case of a larger network size. FIG. 7 also shows that when the number of nodes 104 increases, the optimal value of p₀ corresponding to the maximum throughput decreases. This can be understood qualitatively by noting that more collisions can occur in the system with a larger size, such that a lower p₀ is required to reduce these collisions.

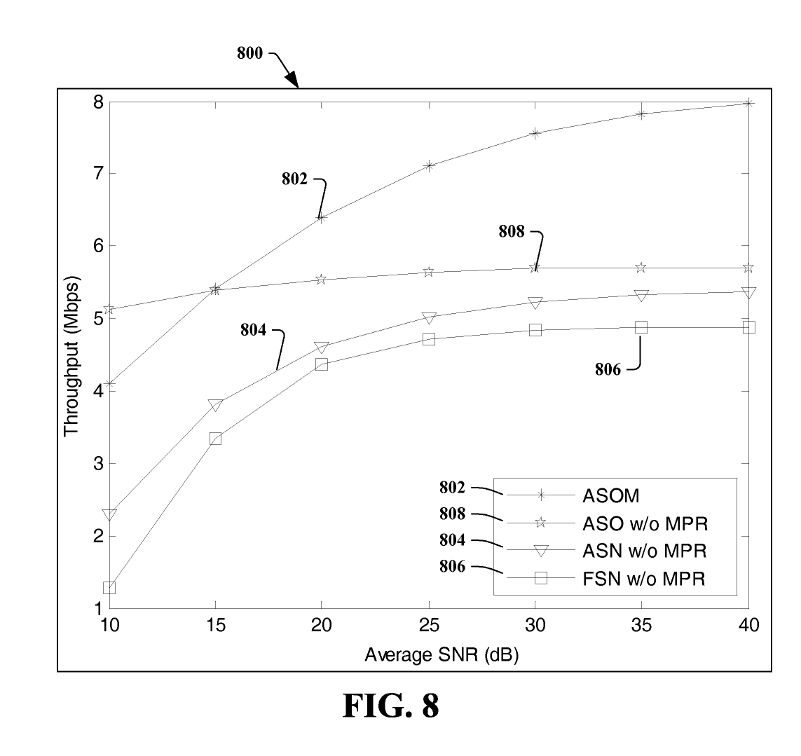

FIG. 8 illustrates the comparative throughput benefits via incorporation of various non-limiting embodiments of the disclosed subject matter in varying Signal to Noise Ratio (SNR) conditions. Accordingly, the throughput of particular non-limiting embodiments under different values of average SNR is shown with a network population of 50 nodes 104 (n=50). The particular non-limiting embodiment that adopts adaptive modulation and the optimal p₀ with MPR capability N=4 is referred as to Adaptive Scheme using Optimal p₀ and MPR (ASOM) 802. In the conventional schemes, no MPR is adopted and p₀=1. Both adaptive modulation and fixed modulation are shown for such conventional schemes. For convenience, the scheme using adaptive modulation is referred to as Adaptive Scheme using Non-optimal p₀ without MPR (ASN w/o MPR) 804, and the one using fixed modulation (specifically, QPSK is depicted) is referred to as Fixed Scheme using Non-optimal p₀ without MPR (FSN w/o MPR) 806. Another scheme used for comparison is the one that uses adaptive modulation and the optimal value of p₀ but without MPR, (N=1). It is referred to as Adaptive Scheme using Optimal p₀ without MPR (ASO w/o MPR) 808.

Note that both of ASOM 802 and ASO w/o MPR 808 are special cases of the particular non-limiting embodiments. Moreover, in ASO w/o MPR 808, ASN w/o MPR 704 and FSN w/o MPR 806, no spreading is used and as a result, the symbol rate is higher in these schemes. As shown in FIG. 8, however, due to the advantages of MPR (e.g. 802), which can advantageously reduce the collisions while increasing the number of simultaneous transmissions, ASOM 802 still significantly outperforms the other schemes in most cases, expect in the extremely low SNR region.

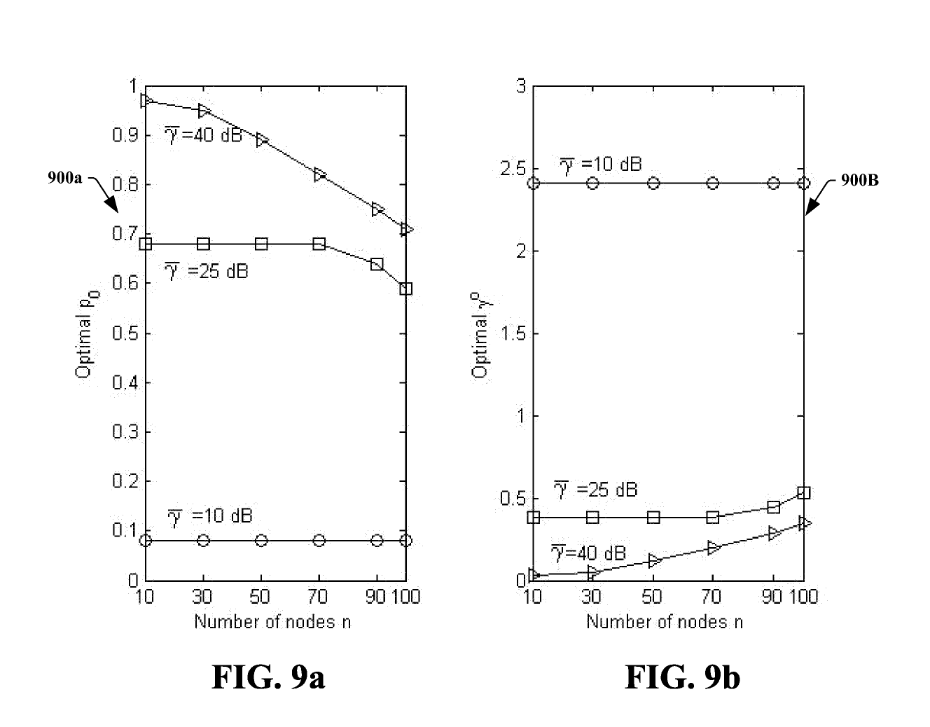

FIG. 9 illustrates optimal values of p₀ 800a and γ⁰ 900b versus different network sizes, where γ⁰ denotes the optimal γ₀ normalized by γ̅. Note that the larger p₀ is, the smaller is γ⁰. Three cases of γ̅=10 dB, 25 dB and 40 dB are shown, respectively. It can be seen from FIG. 9 that the higher the SNR is, the larger the optimal p₀ is. Moreover, the optimal p₀ decreases as the number of nodes increases. Nevertheless, as shown in this figure, the decrease of the optimal value for p₀ is negligible when SNR=10 dB. As mentioned above, p₀ is very small at such low SNR. This implies that, there is no need to further reduce the value of p₀ to avoid collisions, even if the network size increases. In contrast, an optimal p₀ can be required to balance the trade-off between the number of idle slots and the data packets' transmission rate. As a result, the optimal values of p₀ are basically independent of the network sizes, in the case of low SNR range.

### Exemplary Computer Networks and Environments

One of ordinary skill in the art can appreciate that various embodiments of the disclosed subject matter can be implemented in connection with any computer or other client or server device, which can be deployed as part of a computer network, or in a distributed computing environment, connected to any kind of data store. In this regard, the disclosed subject matter pertains to any computer system or environment having any number of memory or storage units, and any number of applications and processes occurring across any number of storage units or volumes, which can be used in connection with the various non-limiting embodiments of Medium Access Control in accordance with the disclosed subject matter. The disclosed subject matter can apply to an environment with server computers and client computers deployed in a network environment or a distributed computing environment, having remote or local storage. The various non-limiting embodiments of the disclosed subject matter can also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices can have applications, objects or resources that can implicate the Medium Access Control operations of the disclosed subject matter.

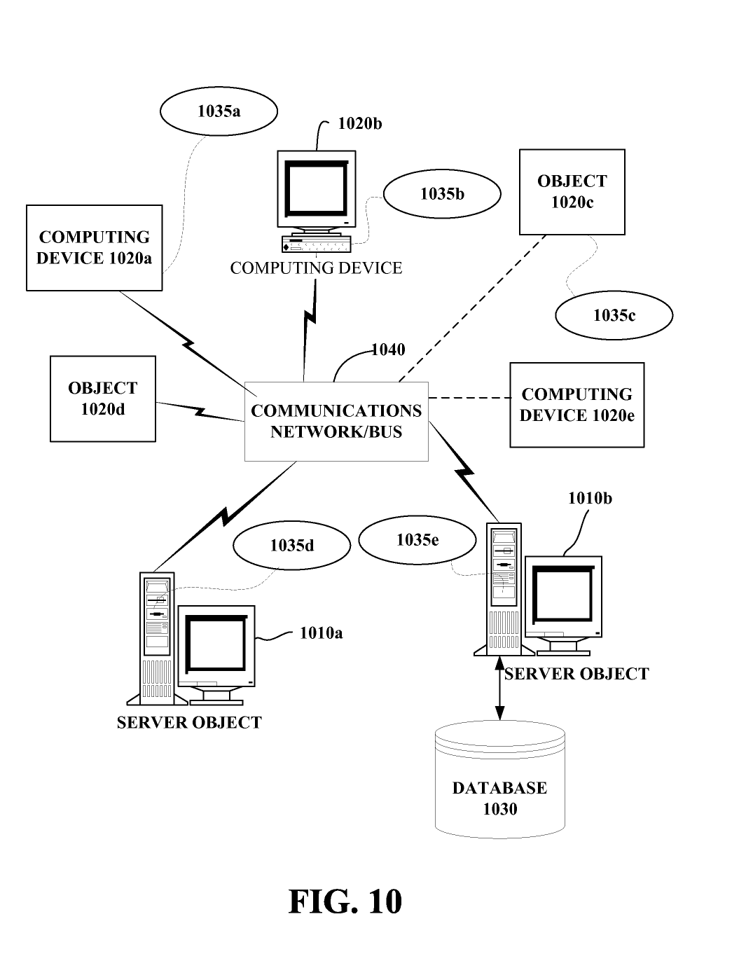

FIG. provides a schematic diagram of an exemplary networked or distributed computing environment. The distributed computing environment comprises computing objects 1010a, 1010b, etc. and computing objects or devices 1020a, 1020b, 1020c, 1020d, 1020e, etc. These objects can comprise programs, methods, data stores, programmable logic, etc. The objects can comprise portions of the same or different devices such as PDAs, audio/video devices, MP3 players, personal computers, etc. Each object can communicate with another object by way of the communications network 1040. This network can itself comprise other computing objects and computing devices that provide services to the system of FIG. 10, and can itself represent multiple interconnected networks. In accordance with an aspect of the disclosed subject matter, each object 1010a, 1010b, etc. or 1020a, 1020b, 1020c, 1020d, 1020e, etc. can contain an application that might make use of an API, or other object, software, firmware and/or hardware, suitable for use with the design framework in accordance with embodiments of the disclosed subject matter.

It can also be appreciated that an object, such as 1020c, can be hosted on another computing device 1010a, 1010b, etc. or 1020a, 1020b, 1020c, 1020d, 1020e, etc. Thus, although the physical environment depicted may show the connected devices as computers, such illustration is merely exemplary and the physical environment can alternatively be depicted or described comprising various digital devices such as PDAs, televisions, MP3 players, etc., any of which can employ a variety of wired and wireless services, software objects such as interfaces, COM objects, and the like.

There are a variety of systems, components, and network configurations that support distributed computing environments. For example, computing systems can be connected together by wired or wireless systems, by local networks or widely distributed networks. Currently, many of the networks are coupled to the Internet, which provides an infrastructure for widely distributed computing and encompasses many different networks. Any of the infrastructures can be used for communicating information used in the Medium Access Control according to embodiments of the disclosed subject matter.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, e.g. roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 10, as an example, computers 1020a, 1020b, 1020c, 1020d, 1020e, etc. can be thought of as clients and computers 1010a, 1010b, etc. can be thought of as servers where servers 1010a, 1010b, etc. maintain the data that is then replicated to client computers 1020a, 1020b, 1020c, 1020d, 1020e, etc., although any computer can be considered a client, a server, or both, depending on the circumstances. Any of these computing devices can be processing data or requesting services or tasks that can use or implicate Medium Access Control in accordance with various non-limiting embodiments of the disclosed subject matter.

A server is typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to various non-limiting embodiments for Medium Access Control of the disclosed subject matter can be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g. client(s) and server(s) can be coupled to one another via TCP/IP connection(s) for high-capacity communication.

Thus, FIG. 10 illustrates an exemplary networked or distributed environment, with server(s) in communication with client computer (s) via a network/bus, in which the various non-limiting embodiments of the disclosed subject matter can be employed. In more detail, a number of servers 1010a, 1010b, etc. are interconnected via a communications network/bus 1040, which can be a LAN, WAN, intranet, GSM network, the Internet, etc., with a number of client or remote computing devices 1020a, 1020b, 1020c, 1020d, 1020e, etc., such as a portable computer, handheld computer, thin client, networked appliance, or other device, such as a VCR, TV, oven, light, heater and the like which can implicate various non-limiting embodiments of the disclosed subject matter. It is thus contemplated that embodiments of the disclosed subject matter can apply to any computing device in connection with which it is desirable to communicate data over a network, or incident thereto.

In a network environment in which the communications network/bus 1040 is the Internet, for example, the servers 1010a, 1010b, etc. can be Web servers with which the clients 1020a, 1020b, 1020c, 1020d, 1020e, etc. communicate via any of a number of known protocols such as HTTP. Servers 1010a, 1010b, etc. can also serve as clients 1020a, 1020b, 1020c, 1020d, 1020e, etc., as can be characteristic of a distributed computing environment.

As mentioned, communications can be wired or wireless, or a combination, where appropriate. Client devices 1020a, 1020b, 1020c, 1020d, 1020e, etc. may or may not communicate via communications network/bus 14, and can have independent communications associated therewith. For example, in the case of a TV or VCR, there may or may not be a networked aspect to the control thereof. Each client computer 1020a, 1020b, 1020c, 1020d, 1020e, etc. and server computer 1010a, 1010b, etc. can be equipped with various application program modules or objects 1035a, 1035b, 1035c, etc. and with connections or access to various types of storage elements or objects, across which files or data streams can be stored or to which portion(s) of files or data streams can be downloaded, transmitted or migrated. Any one or more of computers 1010a, 1010b, 1020a, 1020b, 1020c, 1020d, 1020e, etc. can be responsible for the maintenance and updating of a database 1030 or other storage element, such as a database or memory 1030 for storing data processed or saved according to, or incident to, various non-limiting embodiments of the disclosed subject matter. Thus, the disclosed subject matter can be utilized in a computer network environment having client computers 1020a, 1020b, 1020c, 1020d, 1020e, etc. that can access and interact with a computer network/bus 1040 and server computers 1010a, 1010b, etc. that can interact with client computers 1020a, 1020b, 1020c, 1020d, 1020e, etc. and other like devices, and databases 1030.

### Exemplary Computing Device

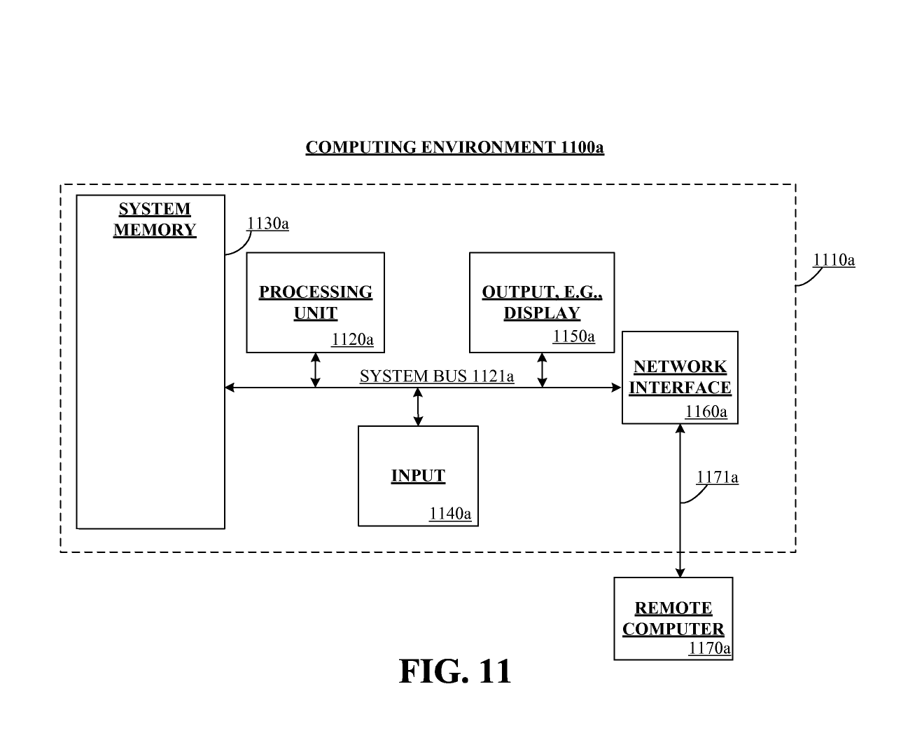

As mentioned, the disclosed subject matter applies to any device wherein it may be desirable to communicate data, e.g. to or from a mobile device. It should be understood, therefore, that handheld, portable and other computing devices and computing objects of all kinds are contemplated for use in connection with various non-limiting embodiments of the disclosed subject matter, e.g. anywhere that a device can communicate data or otherwise receive, process or store data using systems or methods as disclosed. Accordingly, the below general purpose remote computer described below in FIG. 11 is but one example, and exemplary non-limiting embodiments of the disclosed subject matter can be implemented with any client having network/bus interoperability and interaction. Thus, embodiments of the disclosed subject matter can be implemented in an environment of networked hosted services in which very little or minimal client resources are implicated, e.g. a networked environment in which the client device serves merely as an interface to the network/bus, such as an object placed in an appliance.

Although not required, various non-limiting embodiments of the disclosed subject matter, and/or portions thereof, can be partly implemented via an operating system, for use by a developer of services for a device or object, and/or included within application software that operates in connection with the component(s) of the disclosed subject matter. Software can be described in the general context of computer-executable instructions, such as program modules, being executed by one or more computers, such as client workstations, servers or other devices. Those skilled in the art will appreciate that the disclosed subject matter can be practiced with other computer system configurations and protocols.

FIG. 11 thus illustrates an example of a suitable computing system environment 1100a in which embodiments of the disclosed subject matter can be implemented, although as made clear above, the computing system environment 1100a is only one example of a suitable computing environment for a media device and is not intended to suggest any limitation as to the scope of use or functionality of embodiments of the disclosed subject matter. Neither should the computing environment 1100a be interpreted as having any dependency or requirement relating to any one or combination of components illustrated in the exemplary operating environment 1100a.

With reference to FIG. 11, an exemplary remote device for implementing embodiments of the disclosed subject matter includes a general purpose computing device in the form of a computer 1110a. Components of computer 1110a can include, but are not limited to, a processing unit 1120a, a system memory 1130a, and a system bus 1121a that couples various system components including the system memory to the processing unit 1120a. The system bus 1121a can be any of several types of bus structures including a memory bus or memory controller, a peripheral bus, and a local bus using any of a variety of bus architectures.

Computer 1110a typically includes a variety of computer readable media. Computer readable media can be any available media that can be accessed by computer 1110a. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1110a. Communication media typically embodies computer readable instructions, data structures, program modules or other data in a modulated data signal such as a carrier wave or other transport mechanism and includes any information delivery media.

The system memory 1130a can include computer storage media in the form of volatile and/or nonvolatile memory such as read only memory (ROM) and/or random access memory (RAM). A basic input/output system (BIOS), containing the basic routines that help to transfer information between elements within computer 1110a, such as during start-up, can be stored in memory 1130a. Memory 1130a typically also contains data and/or program modules that are immediately accessible to and/or presently being operated on by processing unit 1120a. By way of example, and not limitation, memory 1130a can also include an operating system, application programs, other program modules, and program data.

The computer 1110a can also include other removable/non-removable, volatile/nonvolatile computer storage media. For example, computer 1110a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1121a through a non-removable memory interface such as an interface, and a magnetic disk drive or optical disk drive is typically connected to the system bus 1121a by a removable memory interface, such as an interface.

A user can enter commands and information into the computer 1110a through input devices such as a keyboard and pointing device, commonly referred to as a mouse, trackball or touch pad. Other input devices can include a microphone, joystick, game pad, satellite dish, scanner, or the like. These and other input devices are often connected to the processing unit 1120a through user input 1140a and associated interface(s) that are coupled to the system bus 1121a, but can be connected by other interface and bus structures, such as a parallel port, game port or a universal serial bus (USB). A graphics subsystem can also be connected to the system bus 1121a. A monitor or other type of display device is also connected to the system bus 1121a via an interface, such as output interface 1150a, which can in turn communicate with video memory. In addition to a monitor, computers can also include other peripheral output devices such as speakers and a printer, which can be connected through output interface 1150a.

The computer 1110a can operate in a networked or distributed environment using logical connections to one or more other remote computers, such as remote computer 1170a, which can in turn have media capabilities different from device 1110a. The remote computer 1170a can be a personal computer, a server, a router, a network PC, a peer device or other common network node, or any other remote media consumption or transmission device, and can include any or all of the elements described above relative to the computer 1110a. The logical connections depicted in FIG. 11 include a network 1171a, such local area network (LAN) or a wide area network (WAN), but can also include other networks/buses. Such networking environments are commonplace in homes, offices, enterprise-wide computer networks, intranets and the Internet.

When used in a LAN networking environment, the computer 1110a is connected to the LAN 1171a through a network interface or adapter. When used in a WAN networking environment, the computer 1110a typically includes a communications component, such as a modem, or other means for establishing communications over the WAN, such as the Internet. A communications component, such as a modem, which can be internal or external, can be connected to the system bus 1121a via the user input interface of input 1140a, or other appropriate mechanism. In a networked environment, program modules depicted relative to the computer 1110a, or portions thereof, can be stored in a remote memory storage device. It will be appreciated that the network connections shown and described are exemplary and other means of establishing a communications link between the computers can be used.

While the disclosed subject matter has been described in connection with the preferred embodiments of the various figures, it is to be understood that other similar embodiments can be used or modifications and additions can be made to the described embodiment for performing the same functions of the exemplary embodiments of the disclosed subject matter, and/or portions thereof without deviating therefrom. For example, one skilled in the art will recognize that the disclosed subject matter as described in the present application applies to MAC systems and methods and can be applied to any number of devices connected via a communications network and interacting across the network. In addition, it is understood that in various network configurations, access points can act as nodes and nodes can act as access points for some purposes. Therefore, the disclosed subject matter should not be limited to any single embodiment, but rather should be construed in breadth and scope in accordance with the appended claims.

### Exemplary Communications Networks and Environments

The above-described optimization algorithms and processes can be applied to any network, however, the following description sets forth some exemplary telephony radio networks and non-limiting operating environments for communications made incident to the Medium Access Control systems. The below-described operating environments should be considered non-exhaustive, however, and thus the below-described network architecture merely shows one network architecture into which various embodiments of the disclosed subject matter may be incorporated. One can appreciate, however, that embodiments of the disclosed subject matter can be incorporated into any now existing or future alternative architectures for communication networks as well.

The global system for mobile communication (“GSM”) is one of the most widely utilized wireless access systems in today's fast growing communication systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the techniques according to embodiments of the disclosed subject matter can be applied independently of the method of data transport, and does not depend on any particular network architecture, or underlying protocols.

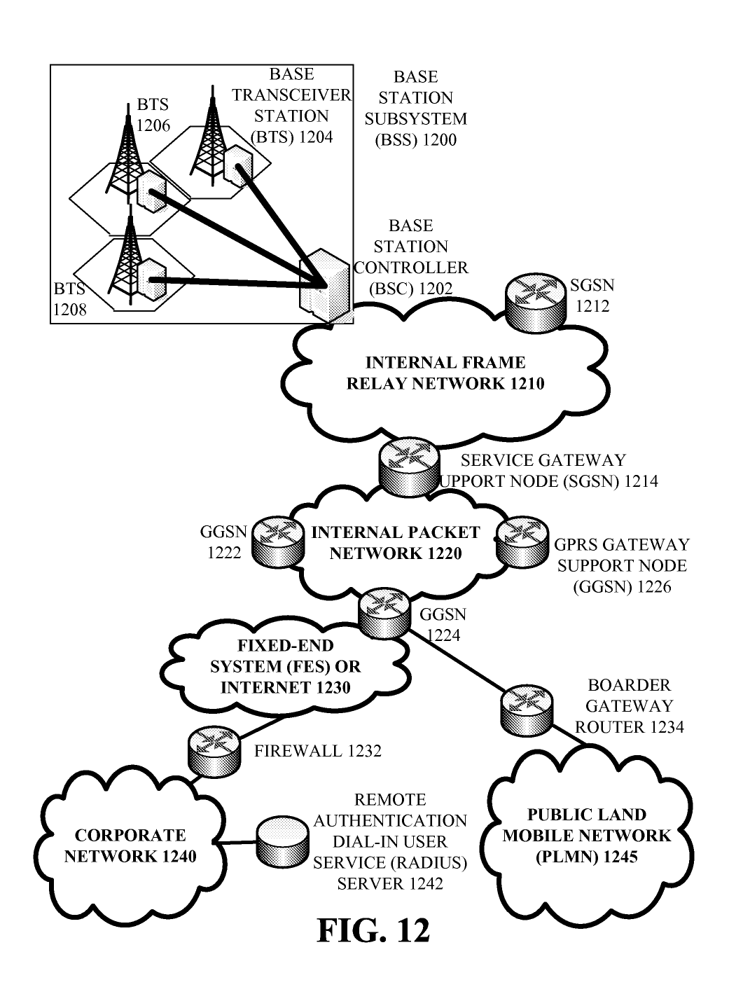

FIG. 12 depicts an overall block diagram of an exemplary packet-based mobile cellular network environment, such as a GPRS network, in which embodiments the disclosed subject matter can be practiced. In such an environment, there are a plurality of Base Station Subsystems (“BSS”) 1200 (only one is shown), each of which comprises a Base Station Controller (“BSC”) 1202 serving a plurality of Base Transceiver Stations (“BTS”) such as BTSs 1204, 1206, and 1208. BTSs 1204, 1206, 1208, etc. are the access points where users of packet-based mobile devices become connected to the wireless network. In exemplary fashion, the packet traffic originating from user devices is transported over the air interface to a BTS 1208, and from the BTS 1208 to the BSC 1202. Base station subsystems, such as BSS 1200, are a part of internal frame relay network 1210 that can include Service GPRS Support Nodes (“SGSN”) such as SGSN 1212 and 1214. Each SGSN is in turn connected to an internal packet network 1220 through which a SGSN 1212, 1214, etc. can route data packets to and from a plurality of gateway GPRS support nodes (GGSN) 1222, 1224, 1226, etc. As illustrated, SGSN 1214 and GGSNs 1222, 1224, and 1226 are part of internal packet network 1220. Gateway GPRS serving nodes 1222, 1224 and 1226 mainly provide an interface to external Internet Protocol (“IP”) networks such as Public Land Mobile Network (“PLMN”) 1245, corporate intranets 1240, or Fixed-End System (“FES”) or the public Internet 1230. As illustrated, subscriber corporate network 1240 can be connected to GGSN 1224 via firewall 1232; and PLMN 1245 is connected to GGSN 1224 via boarder gateway router 1234. The Remote Authentication Dial-In User Service (“RADIUS”) server 1242 can be used for caller authentication when a user of a mobile cellular device calls corporate network 1240.

Generally, there can be four different cell sizes in a GSM network—macro, micro, pico and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the disclosed subject matter described herein can have aspects that are wholly in hardware, partly in hardware and partly in software, as well as in software. Furthermore, aspects can be fully integrated into a single component, be assembled from discrete devices, or implemented as a combination suitable to the particular application and is a matter of design choice. As used herein, the terms “node,” “access point,” “component,” “system,” and the like are likewise intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on computer and the computer can be a component. One or more components can reside within a process and/or thread of execution and a component can be localized on one computer and/or distributed between two or more computers.

Thus, the embodiments of the disclosed subject matter, or certain aspects or portions thereof, can take the form of program code (e.g., instructions) embodied in tangible media, such as floppy diskettes, CD-ROMs, hard drives, or any other machine-readable storage medium, wherein, when the program code is loaded into and executed by a machine, such as a computer, the machine becomes an apparatus or component of a system for practicing embodiments of the disclosed subject matter. In the case of program code execution on programmable computers, the computing device generally includes a processor, a storage medium readable by the processor (including volatile and non-volatile memory and/or storage elements), at least one input device, and at least one output device as described above.

Furthermore, embodiments of the disclosed subject matter can be implemented as a system, method, apparatus, or article of manufacture using standard programming and/or engineering techniques to produce software, firmware, hardware, or any combination thereof to control a computer or processor based device to implement aspects detailed herein. The terms “article of manufacture”, “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed in a computer readable transmission medium to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but generally known by those of skill in the art.

In view of the exemplary systems described supra, methodologies that can be implemented in accordance with embodiments of the disclosed subject matter will be better appreciated with reference to the flowcharts of various figures herein. While for purposes of simplicity of explanation, the methodologies are shown and described as a series of blocks, it is to be understood and appreciated that the claimed subject matter is not limited by the order of the blocks, as some blocks can occur in different orders and/or concurrently with other blocks from what is depicted and described herein. Where non-sequential, or branched, flow is illustrated via flowchart, it can be appreciated that various other branches, flow paths, and orders of the blocks, can be implemented which achieve the same or a similar result. Moreover, not all illustrated blocks may be required to implement the methodologies described hereinafter.

Furthermore, as will be appreciated various portions of the disclosed systems above and methods below can include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the disclosed subject matter has been described in connection with the preferred embodiments of the various figures, it is to be understood that other similar embodiments can be used or modifications and additions can be made to the described embodiments for performing the same functions of embodiments, or portions thereof, of the disclosed subject matter without deviating therefrom.

While exemplary embodiments may refer to utilizing the disclosed subject matter in the context of particular programming language constructs, specifications or standards, the various embodiments of the disclosed subject matter is not so limited, but rather can be implemented in any language to perform the Medium Access Control in accordance with the exemplary non-limiting embodiments of the disclosed subject matter. Still further, embodiments of the disclosed subject matter can be implemented in or across a plurality of processing chips or devices, and storage can similarly be effected across a plurality of devices. Therefore, embodiments of the disclosed subject matter should not be limited to any single embodiment, but rather should be construed in breadth and scope in accordance with the appended claims.

What is claimed is:

1. A method of accessing a wireless network comprising:
determining a current channel condition for a node of the wireless network;
determining a channel state threshold;
comparing the current channel condition for the node with the channel state threshold; and
selectively transmitting at least a request to send signal, based on the comparing of the current channel condition for the node with the channel state threshold.

2. The method according to claim 1, wherein the determining includes determining the current channel condition for the node of a wireless network substantially conforming to an Institute of Electrical and Electronics Engineers (IEEE) 802.11 standard wireless network specification.

3. The method according to claim 1, the determining the current channel condition includes determining the current channel condition based at least in part on a current channel signal to noise ratio.

4. The method according to claim 1, the determining the channel state threshold includes determining the channel state threshold based at least in part on determining a signal to noise ratio (SNR) threshold.

5. The method according to claim 4, the determining the SNR threshold includes determining the SNR threshold based at least in part on at least one multi-packet reception capability of the wireless network.

6. The method according to claim 4, the determining the SNR threshold includes determining the SNR threshold based at least in part on a network population of the wireless network.

7. A computer readable medium comprising computer executable instructions for performing the method of claim 1.

8. A system for providing wireless network access comprising:
a wireless access component having multi-packet reception capabilities;
at least one wireless network node, the at least one wireless network node further comprising a selective transmitting component for selectively transmitting to the wireless access component, the at least one wireless network node having an associated current channel condition; and
the selective transmitting component configured to dynamically determine a transmitting decision based at least in part on the multi-packet reception capabilities of the wireless access component and the current channel condition associated with the at least one wireless network node.

9. The system according to claim 8, the wireless access component substantially conforms to an Institute of Electrical and Electronics Engineers (IEEE) 802.11 standard wireless network specification.

10. The system according to claim 8, the multi-packet reception capabilities is provided according to one of time division, frequency division, code division, and orthogonal frequency division multiple access schemes.

11. The system according to claim 8, the associated current channel condition is based at least in part on an associated current channel Signal to Noise Ratio.

12. The system according to claim 8, the transmitting decision is further based on a network population.

13. A wireless device for accessing a wireless network comprising:
a memory that retains executable instructions for comparing a channel state of the wireless device with a channel state threshold and for selectively transmitting at least a request to send signal, based on comparing of the channel state with the channel state threshold; and
a processor communicatively coupled to the memory and operable to execute the executable instructions.

14. The wireless device of claim 13, the wireless device substantially conforms to an Institute of Electrical and Electronics Engineers (IEEE) 802.11 standard wireless network specification.

15. The wireless device of claim 13, the channel state is determined based on a channel Signal to Noise Ratio of the wireless device.

16. The wireless device of claim 13, the channel state threshold comprises a Signal to Noise Ratio threshold.

17. The wireless device of claim 16, the Signal to Noise Ratio threshold is based in part on a multi-packet reception capability of a wireless network in communication with the wireless device.

18. The wireless device of claim 17, the Signal to Noise Ratio threshold is based in part on a number of wireless devices in communication with the wireless network.

19. The wireless device of claim 17, the multi-packet reception capability includes one of time division, frequency division, code division, and orthogonal frequency division multiple access schemes.

20. The wireless device of claim 17, the executable instructions further comprising instructions for decreasing a backoff counter if a transmission medium is idle.
